(19) United States
(12) Patent Application Publication
(10) Pub. No.: US 2026/0010619 A1
(43) Pub. Date: Jan. 8, 2026

(54) Data Processing Apparatus and Method for Runtime Integrity Attestation

(71) Applicant: HUAWEI TECHNOLOGIES CO., LTD., Shenzhen, Guangdong (CN)

(72) Inventors: Mahmoud Ammar, Munich (DE); Ahmed Abdelraoof, Munich (DE); Ioan-Silviu Vlasceanu, Munich (DE)

(73) Assignee: HUAWEI TECHNOLOGIES CO., LTD., Shenzhen, Guangdong (CN)

(21) Appl. No.: 19/288,407

(22) Filed: Aug. 1, 2025

Related U.S. Application Data
(63) Continuation of application No. PCT/EP2023/052437, filed on Feb. 1, 2023.

(51) Int. Cl. G06F 21/54; G06F 9/30

(52) U.S. Cl. CPC G06F 21/54; G06F 9/30058; G06F 2221/033

(57) ABSTRACT

A data processing apparatus includes a processing circuitry configured to execute a modified version of an application machine code defining the application. The modified version of the application machine code comprises one or more direct or indirect branch instructions and one or more machine code instructions being one or more target instructions for the one or more direct or indirect branch instructions. During the execution of the modified version of the application machine code, the processing circuitry is further configured to update a first register value in a first register and a second register value in a second register and to trigger an exception, based on the first register value and the second register value and/or when the one or more direct or indirect branch instructions target an instruction of the modified version of the application machine code.

### CROSS-REFERENCE TO RELATED APPLICATIONS

This is a continuation of International Patent Application No. PCT/EP2023/052437 filed on Feb. 1, 2023, which is hereby incorporated by reference.

### TECHNICAL FIELD

The present disclosure relates to security technology. In particular, the present disclosure relates to data processing apparatus, a runtime attestation system and a method for runtime attestation.

### BACKGROUND

Some computing systems are often implemented using potentially unsafe programming languages, such as C and C++, and hence insecure. Memory corruption bugs are the biggest attack vector in such systems. These bugs can be exploited in different attack forms. The main two attack classes are (i) code injection attacks, and (ii) code reuse attacks. The widespread deployment of Data Execution Prevention (DEP) technologies as a defense has raised the bar for attackers to successfully mount code injection attacks. Therefore, code-reuse attacks have become the most popular software exploitation technique in the past decade. They can be classified to either control-flow hijacking attacks or non-control data attacks. Control-flow hijacking techniques are widely used in launching attacks. There are basically two main techniques called Return Oriented Programming (ROP) and Jump Oriented Programming (JOP).

ROP is a classical exploit technique, by which an attacker exploits a memory corruption vulnerability to gain control of the call stack to hijack program control flow and then executes carefully chosen machine instruction sequences, called gadgets, which are already present in the code memory of the target device. Each gadget typically ends in a return instruction and is located in a subroutine within the existing program or shared library code. By chaining these gadgets together, the attacker would be able to perform a malicious task.

JOP is similar to ROP in the sense that the target software is scanned for gadgets that can be stitched together to perform out-of-control-flow task. ROP attacks look for sequences that end with a function return (RET). In contrast, JOP attacks target sequences that end with indirect jump or call instructions and can be linked together through a special gadget, called dispatcher, which should also exist in the same memory. Notable is that JOP is considered a variant of ROP that allows for exploits with or without controlling the stack. To do so, a dispatcher gadget should exist to allow jumping to a table of instructions ending with a jump instruction.

Thus, there is a need improved for devices and methods for detecting and preventing control-flow hijacking attacks, such as JOPs and ROPs, in an efficient manner and with incurring minimal performance overhead and for providing trustworthy evidence about the runtime integrity status of a target software in an efficient manner that allows for scalability.

### SUMMARY

It is an objective to provide improved devices and methods for secure and efficient runtime integrity attestation for detecting and preventing control-flow hijacking attacks, such as JOPs and ROPs.

The foregoing and other objectives are achieved by the subject matter of the independent claims. Further implementation forms are apparent from the dependent claims, the description and the figures.

According to a first aspect a data processing apparatus for executing a software application defined by an application machine code, e.g. a target binary image, is provided. The data processing apparatus comprises a processing circuitry configured to execute a modified, e.g. hardened, version of an original version of the application machine code defining the application. The modified version of the application machine code comprises one or more direct or indirect branch instructions and one or more hardware-assisted machine code instructions being one or more valid target instructions for the one or more direct or indirect branch instructions. In the context of processors based, for instance, on the ARM architecture such hardware-assisted machine code instructions are known as landing pad or Branch Target Identification (BTI) instructions (or landmark instructions). During the execution of the modified version of the application machine code the processing circuitry is further configured to update a first register, i.e. state register, value in a first register, i.e. state register, and a second register, i.e. reference register, value in a second register, i.e. reference register, and to trigger an hardware exception, based on the first register value and the second register value and/or if the one or more direct or indirect branch instructions target an instruction of the modified version of the application machine code other than the one or more valid target instructions. Thus, a data processing apparatus is provided enabling a secure and efficient implicit device attestation and integrity verification during the entire lifetime cycle of the execution state of the application.

In a further possible implementation form of the first aspect, the data processing apparatus further comprises a communication interface configured to report attestation data, including information about the first register value and/or the second register value to a verifier server, in case a hardware exception has been triggered. Thus, an exception can be examined by a trusted source.

In a further possible implementation form of the first aspect, the information about the first register value and/or the second register value comprises the first and second register values and/or a digest value, e.g. a hash value, based on the first register value and/or the second register value. Thus, the information about the first register value and/or the second register value can be provided in a compact and secure manner.

In a further possible implementation form of the first aspect, the one or more direct or indirect branch instructions of the modified version of the application machine code comprise one or more direct or indirect call instructions, one or more direct or indirect jump instructions and/or one or more direct or indirect return instructions. Thus, direct or indirect call instructions, direct or indirect jump instructions and/or direct or indirect return instructions can be secured in the modified version of the application machine code.

In a further possible implementation form of the first aspect, for each of the one or more direct or indirect branch instructions of the modified version of the application machine code the processing circuitry is configured to move a current first register value of the first register to the second register, update the current first register value of the first register by an exclusive or (XOR) operation with a unique identifier, in particular key Kx, perform the respective direct or indirect branch instruction, update the current first register value of the first register by a further XOR operation with the unique identifier, in particular key Kx, and compare the updated current first register value with the current second register value. Thus, a chain of unique values can be created using XOR operations, where each value can belong to one certain place.

In a further possible implementation form of the first aspect, the processing circuitry is further configured to trigger a hardware exception, if the updated current first register value differs from the current second register value. Thus, if a value was tampered with, it can be detected in an efficient manner and an exception can be triggered.

In a further possible implementation form of the first aspect, the processing circuitry is configured to generate or to obtain the unique identifier for each of the one or more direct or indirect branch instructions of the modified version of the application machine code. Thus, each of the one or more direct or indirect branch instructions of the modified version of the application machine code can be uniquely identified.

In a further possible implementation form of the first aspect, the first register, i.e. state register, and the second register, i.e. reference register, are configured to be modified only by an assignment, in particular, a move (MOV) instruction, an XOR instruction, and a compare, in particular, a compare (CMP) instruction. Thus, the first register and the second register can only be used for checking the direct or indirect branch instructions.

In a further possible implementation form of the first aspect, the modified version of the application machine code comprises for one or more return instructions of the original version of the application machine code a hard-coded jump table defining one or more jump destinations. Thus, the return instruction can be replaced in a secure manner.

In a further possible implementation form of the first aspect, the processing circuitry is further configured to link the first register value of the first register with a memory address of the one or more jump destinations defined by the jump tables for minimizing the look-up time in the hard-coded jump tables. Thus, the look-up time in the hard-coded jump tables can be minimized.

According to a second aspect a runtime attestation system is provided. The runtime attestation system comprises at least one data processing apparatus according to the first aspect configured to generate attestation data, and a verifier server configured to receive the attestation data from the at least one data processing apparatus and to attest the integrity of the at least one data processing apparatus based on the attestation data. Thus, an efficient system for runtime attestation is provided.

According to a third aspect a method for executing a software application defined by an application machine code, e.g., a target binary image, is provided. The method comprises executing a modified version of an application machine code defining the application, wherein the modified version of the application machine code comprises one or more direct or indirect branch instructions and one or more machine code instructions being one or more target instructions for the one or more direct or indirect branch instructions, updating a first register value in a first register and a second register value in a second register, and triggering an exception, based on the first register value and the second register value and/or if the one or more direct or indirect branch instructions target an instruction of the modified version of the application machine code other than the one or more target instructions. Thus, a method is provided enabling a secure and efficient implicit device attestation and integrity verification during the entire lifetime cycle of the execution state of the application.

The method according to the third aspect of the present disclosure can be performed by the data processing apparatus according to the first aspect of the present disclosure. Thus, further features of the method according to the third aspect of the present disclosure result directly from the functionality of the data processing apparatus according to the first aspect of the present disclosure as well as its different implementation forms described above and below.

According to a fourth aspect a data processing apparatus is provided, wherein the data processing apparatus according to the fourth aspect is configured to modify an original version of an application machine code defining a software application into a modified, e.g. hardened, version of the application machine code. The original version of the application machine code comprises one or more direct or indirect branch instructions. The data processing apparatus is configured to include for each of the one or more direct or indirect branch instructions of the original version of the application machine code one or more hardware-assisted machine code instructions, in particular landmark or landing pad instructions, indicating one or more valid target instructions for the one or more direct or indirect branch instructions for obtaining the modified, e.g. hardened, version of the application machine code. The data processing apparatus is further configured to compile the modified, e.g. hardened, version of the application machine code into an executable binary image. Thus, a data processing apparatus is provided for providing a hardened more secure version of an application machine code.

In a further possible implementation form of the fourth aspect, the one or more direct or indirect branch instructions comprise one or more direct or indirect call instructions, and/or one or more direct or indirect jump instructions and/or one or more direct or indirect return instructions. Thus, direct or indirect call instructions, direct or indirect jump instructions and/or direct or indirect return instructions can be secured in the hardened version of the application machine code.

In a further possible implementation form of the fourth aspect, the original version of the application machine code comprises one or more return instructions and the data processing apparatus is configured to include for each of the one or more return instructions a hard-coded jump table defining one or more jump destinations. Thus, the return instruction can be replaced in a secure manner.

Details of one or more embodiments are set forth in the accompanying drawings and the description below. Other features, objects, and advantages will be apparent from the description, drawings, and claims.

### BRIEF DESCRIPTION OF THE DRAWINGS

In the following, some embodiments of the present disclosure are described in more detail with reference to the attached figures and drawings.

FIG. 1 shows a schematic diagram illustrating a runtime attestation system according to an embodiment comprising a least one first data processing apparatus according to an embodiment and a verifier server;

FIG. 2 shows a schematic diagram illustrating architectures of a first data processing apparatus according to an embodiment and a second data processing apparatus according to an embodiment;

FIG. 3 shows an exemplary flow graph illustrating a function-level control of a second data processing apparatus according to an embodiment;

FIG. 4A, FIG. 4B, FIG. 4C, FIG. 4D, and FIG. 4E show instrumentation effects on several functions indicating call instructions;

FIG. 5 shows a schematic diagram illustrating functions with ROP gadgets;

FIG. 6 shows a compiling process performed by a second data processing according to an embodiment in more detail;

FIG. 7 is a flow diagram illustrating an instrumentation sequence implemented by a second data processing apparatus according to an embodiment during compilation;

FIG. 8 is a schematic diagram illustrating an architecture of the runtime attestation system according to an embodiment at runtime; and

FIG. 9 shows a flow diagram illustrating a method for executing a software application defined by an application machine code.

In the following, identical reference signs refer to identical or at least functionally equivalent features.

### DETAILED DESCRIPTION OF THE EMBODIMENTS

In the following description, reference is made to the accompanying figures, which form part of the disclosure, and which show, by way of illustration, specific aspects of embodiments of the present disclosure or specific aspects in which embodiments of the present disclosure may be used. It is understood that embodiments of the present disclosure may be used in other aspects and comprise structural or logical changes not depicted in the figures. The following detailed description, therefore, is not to be taken in a limiting sense, and the scope of the present disclosure is defined by the appended claims.

For instance, it is to be understood that a disclosure in connection with a described method may also hold true for a corresponding device or system configured to perform the method and vice versa. For example, if one or a plurality of specific method steps are described, a corresponding device may include one or a plurality of units, e.g. functional units, to perform the described one or plurality of method steps (e.g. one unit performing the one or plurality of steps, or a plurality of units each performing one or more of the plurality of steps), even if such one or more units are not explicitly described or illustrated in the figures. On the other hand, for example, if a specific apparatus is described based on one or a plurality of units, e.g. functional units, a corresponding method may include one step to perform the functionality of the one or plurality of units (e.g. one step performing the functionality of the one or plurality of units, or a plurality of steps each performing the functionality of one or more of the plurality of units), even if such one or plurality of steps are not explicitly described or illustrated in the figures. Further, it is understood that the features of the various exemplary embodiments and/or aspects described herein may be combined with each other, unless noted otherwise.

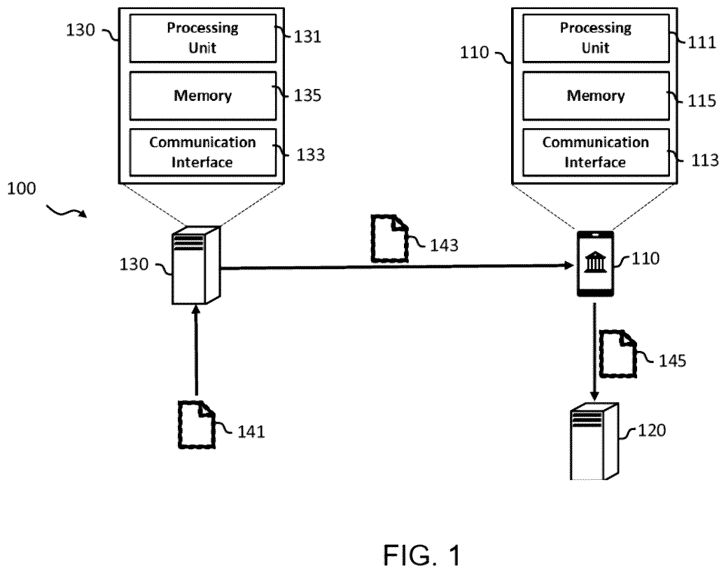

FIG. 1 shows a schematic diagram illustrating a runtime attestation system 100 according to an embodiment comprising a least one first data processing apparatus 110 according to an embodiment and a verifier server 120. The runtime attestation system 100 may further comprise a second data processing apparatus 130 according to an embodiment. The first data processing apparatus 110 may be, for instance, an IOT device, a smartphone, a network device, an electronic control unit and the like. The second data processing apparatus 130 may be, for instance, a server, in particular a cloud server, a base station, a cloud machine, a router and the like. The verifier server 120 may be a cloud server.

As illustrated in FIG. 1 and will be described in more detail below, the first data processing apparatus 110 comprises a processing unit 111, which may comprise, for instance, one or more central processing units (CPUs). The processing unit 111 may be implemented in hardware and/or software and may comprise digital circuitry, or both analog and digital circuitry. Digital circuitry may comprise components such as application-specific integrated circuits (ASICs), field-programmable gate arrays (FPGAs), digital signal processors (DSPs), or general-purpose processors. Moreover, the first data processing apparatus 110 may comprise an electronic non-volatile memory 115 configured to store data, for instance, a FLASH memory 115. The non-volatile memory 115 may store executable program code which, when executed by the processing unit 111, causes the first data processing apparatus 110 to perform the functions and methods described herein. The first data processing apparatus 110 may further comprises a communication interface 113, in particular a wireless and/or wired communication interface allowing the first data processing apparatus 110 to communicate with the verifier server 120, the second data processing apparatus 130 and/or other network devices.

Likewise, the second data processing apparatus 130 may comprise a processing unit 131, which may comprise, for instance, one or more central processing circuitries, CPUs, and/or one or more microcontrollers. The processing unit 131 may be implemented in hardware and/or software and may comprise digital circuitry, or both analog and digital circuitry. Digital circuitry may comprise components such as ASICs, FPGAs, DSPs, or general-purpose processors. Moreover, the second data processing apparatus 130 may comprise an electronic non-volatile memory 135 configured to store data, for instance, a FLASH memory 135. The non-volatile memory 135 may store executable program code which, when executed by the processing unit 131, causes the second data processing apparatus 130 to perform the functions and methods described herein. The second data processing apparatus 130 may further comprises a communication interface 133, in particular a wireless and/or wired communication interface allowing the second data processing apparatus 130 to communicate with the verifier server 120, the first data processing apparatus 110 and/or other network devices.

As will be described in more detail further below, the second data processing apparatus 130 is configured to modify an original version of an application machine code 141 (or source code 141) defining a software application into a modified, e.g. hardened, version 143 of the application machine code 141. The original version of the application machine code 141 comprises one or more direct or indirect branch instructions.

The second data processing apparatus 130 is configured to include for each of the one or more direct or indirect branch instructions of the original version of the application machine code 141 one or more hardware-assisted machine code instructions indicating one or more valid target instructions for the one or more direct or indirect branch instructions for obtaining the modified, e.g. hardened, version 143 of the application machine code 141. In the context of processors based, for instance, on the ARM architecture such hardware-assisted machine code instructions are known as landing pad instructions (or landmark instructions). Further details about landing pad instructions, which according to an embodiment may be used as the hardware-assisted machine code instructions, may be found, for instance, in the document “Learn the architecture-Providing protection for complex software,” Version 2.0, arm, 2020, which is fully incorporated by reference herein. The second data processing apparatus 130 is further configured to compile the modified, e.g. hardened, version 143 of the application machine code 141 into an executable binary image.

Complementary, the at least one first data processing apparatus 110 is configured for executing the software application defined by the application machine code 141, e.g. a target binary image. The processing unit 111 of the first data processing apparatus 110 is configured to execute the modified, e.g. hardened, version 143 of the original version of the application machine code 141 defining the application. During the execution of the modified version 143 of the application machine code 141 the processing unit 111 of the first data processing apparatus 110 is further configured to update a first register, i.e. state register, value in a first register, i.e. state register, and a second register, i.e. reference register, value in a second register, i.e. reference register, and to trigger an hardware exception, based on the first register value and the second register value and/or if the one or more direct or indirect branch instructions target an instruction of the modified version 143 of the application machine code 141 other than the one or more valid target instructions. The first data processing apparatus 110 may be further configured to generate attestation data 145.

The verifier server 120 is configured to receive the attestation data 145 from the at least one first data processing apparatus 110 and to attest the integrity of the at least one first data processing apparatus 110 based on the attestation data 145.

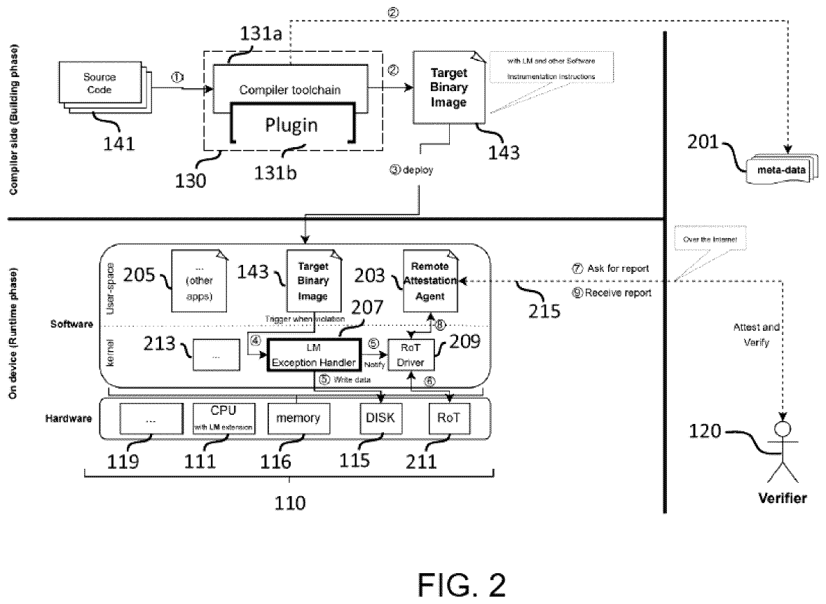

FIG. 2 shows a schematic diagram illustrating architectures of the first data processing apparatus 110 according to an embodiment and the second data processing apparatus 130 according to an embodiment.

As illustrated in FIG. 2, the application may be a user-space application running on an architecture that provides hardware support for a landmark instruction, i.e. an instruction that can be inserted by any valid target for an indirect jump or call and triggers a hardware exception if the target is some other instruction. The processing unit 111 of the first data processing apparatus 110 may be a processing unit 111 which provides the above hardware support, for example an ARM processor for high-end devices such as ARMv8.5-A or higher generations, or for low-end ones such as ARMv8.1-M or for example a 11th generation (or higher generation) of an INTEL Skylake processor.

The verifier server 120 may be a remote trusted entity, e.g., a management service, which gets some meta-data 201 from the deployment service, i.e. the second data processing apparatus 130, after it compiles the corresponding application that can be used in verifying the attestation data 145, i.e. attestation report. At any point in time, the verifier server 120 may contact a remote attestation service or agent 203, i.e. a user-space process, to ask about the runtime integrity status of the first data processing apparatus 110. The remote attestation service 203 may reply with a report that will be verified by the verifier server 120 with respect to the received meta-data 201.

The first data processing apparatus 110 may be an entire untrusted device, i.e. hardware that hosts the software, which operates in a runtime phase.

The hardware components of the first data processing apparatus 110 may comprise the processing unit 111 supporting landmark (LM) instructions, which can be inserted in certain places in the binary software to identify valid targets for indirect branch instructions.

The hardware components of the first data processing apparatus 110 may further comprise the non-volatile memory 115 providing a storage space where software modules and other files may be permanently stored in both of the on and off statuses of the first data processing apparatus 110.

The hardware components of the first data processing apparatus 110 may further comprise a volatile memory 116, for example a dynamic random-access memory (DRAM) that holds all software modules when turning the first data processing apparatus 110 on.

The hardware components of the first data processing apparatus 110 may further comprise a root of trust (RoT) hardware module 211 that may be responsible for generating a chain of trust among the various software layers and thus for detecting any forgeable report.

As will be appreciated, the hardware components of the first data processing apparatus 110 may further comprise further hardware components 119, such as the communication interface 113.

The software components of the first data processing apparatus 110 may comprise in a kernel, i.e. high privileged software that controls other software modules running on top of it, a LM Exception Handler 207. The LM exception handler 207 may be a kernel module that is responsible for handling all violations triggered because of targeting non-LM instructions by indirect jumps or calls.

The software components of the first data processing apparatus 110 may further comprise in the kernel a RoT driver 209. The ROT driver 209 may be a kernel module that is responsible for handling all interactions with the ROT hardware module 211.

The software components of the first data processing apparatus 110 may comprise in a user-space the remote attestation agent 203. The remote attestation agent 203 may be a user-space process (application) that is responsible for receiving commands from the verifier server 120 and answers accordingly after retrieving relative data from other modules.

The software components of the first data processing apparatus 110 may further comprise in the user-space the hardened version 143 of the application machine code 141, i.e. the corresponding user-space application that is monitored and protected as described in embodiments above and below.

As will be appreciated, the software components of the first data processing apparatus 110 may comprise further modules 213 in the kernel and/or further applications 205 in the user-space.

The second data processing apparatus 130 may operate in a building phase, i.e. the compilation process, after which the resulted hardened version 143 of the application machine code 141 has the needed instrumentation instructions.

As described above and below in embodiments, the second data processing apparatus 130 may be provided with the source code 141 comprising all dependent files of the target application.

The second data processing apparatus 130 may comprise, in particular the processing unit 131 of the second data processing apparatus 130 may implement, a compiler toolchain 131a, i.e. a compiler infrastructure 131a used in compiling the target application.

The second data processing apparatus 130 may further comprise, in particular the processing unit 131 of the second data processing apparatus 130 may implement, a plugin 131b. The plugin 131b may be a software library that is implemented and plugged into the compiler toolchain 131a. The plugin 131b may execute when passing its corresponding flag to the compiler infrastructure 131a and may add the needed instrumentation instructions to the target application.

As described above and below in embodiments, the second data processing apparatus 130 may generate the hardened version 143 of the application machine code 141, i.e. the resulted binary file after compilation. The hardened version 143 of the application machine code 141 may then be deployed to the first data processing apparatus 110.

The runtime attestation system may be configured for a hardware/software co-design in order to mitigate control-flow hijacking attacks.

On the hardware side, a landmark technology, such as or similar to the BTI technology (in ARM architecture) may be used in the sense that indirect branch and jump instructions can only target landmark instructions. There may be two landmark instructions added: “lm c” for indirect call instructions, and “lm j” for indirect jump instructions. The hardware side may also comprise two additional registers that are reserved to be used according to embodiments described herein, called state register (SR) and reference register (RR). The hardware may enforce that these two registers may only be used for assignment (MOV), XOR, and compare (CMP) instructions.

On the software side the compiler plugin 131b may be responsible for (i) inserting the lm instructions in their correct places, (ii) instrumenting all call-sites with specific XOR and CMP instructions that use unique generated keys, (iii) replacing return instructions with hard-coded jump tables and (iv) guaranteeing that the two additional registers SR and RR are not used outside their context.

On the software side the custom LM exception handler 207 in the kernel may log all violations when triggered. The LM exception handler 207 may only need to log the two values of the two additional registers SR and RR which are minimal but enough information to verify the logs later by a trusted party, i.e. the verifier server 120.

On the software side a user-space safe process implemented in a safe language, for example Rust, may act as the remote attestation agent 203 to report in a trustworthy way the recorded logs to the verifier server 120.

As described above, the runtime attestation system 100 may operate in two phases: one relates to the building (or compilation) phase, and the other one takes place during execution (or runtime phase). The relevant part may instrument the target software, i.e. the source code 141 and harden it as requires, whereas during runtime, the inserted instructions take care of preventing and detecting control-flow hijacking attacks.

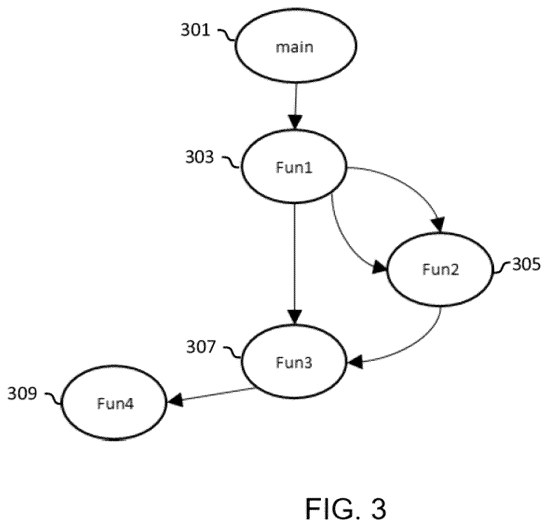

FIG. 3 shows an exemplary flow graph illustrating a function-level control of the second data processing apparatus 130 according to an embodiment. As schematically illustrated in FIG. 3, during the compilation phase, when compiling any application, the plugin 131b may generate a control flow graph at the function-level such as the exemplary graph shown in FIG. 3 comprising a plurality of nodes representing different functions 301-309. All indirect branch instructions may be over-approximated if not resolved accurately.

The plugin 131b may further insert “lm c” at the beginning of each function to limit the valid set of targets for indirect branch instructions.

The plugin 131b may further generate unique keys for each direct/indirect call instruction and may add the following instrumentation. Before an “(ind-)call Xd” for performing the (indirect-)call instruction, add “MOV RR, SR” for moving the value of SR to RR following “XOR SR, Kx” for XORing the value of SR with the unique key Kx and storing it in SR. After the “(ind-)call Xd” for performing the (indirect-)call instruction, add “XOR SR, Kx” for XORing the value of SR again with the same key Kx following “CMP RR, SR” for comparing the value of RR and SR and triggering a LM Exception if not equal.

Thus, each call instruction may be preceded by two instructions and followed by two others, in addition to the instruction that is responsible for triggering an exception. This can create a chain of unique values using XOR operations, where each value should belong to one certain place. If this value was tampered with, it would be detected, and an exception will be triggered.

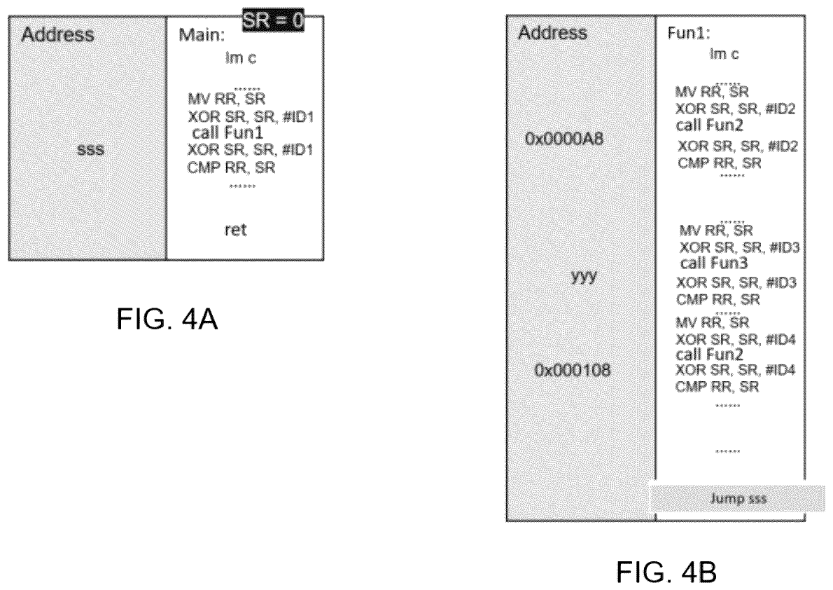

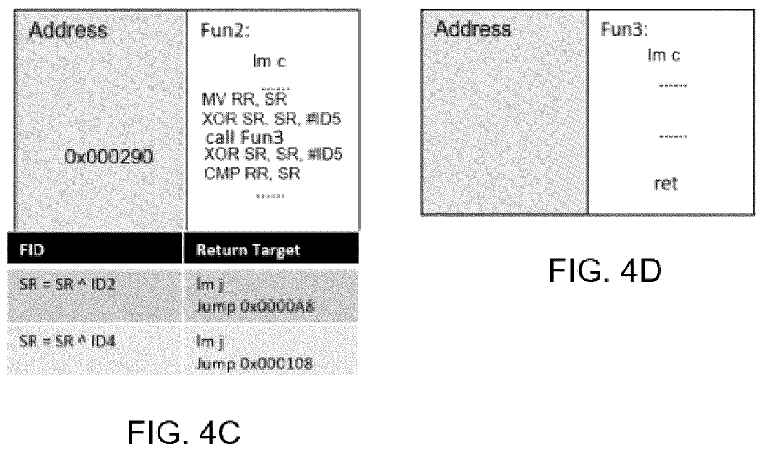

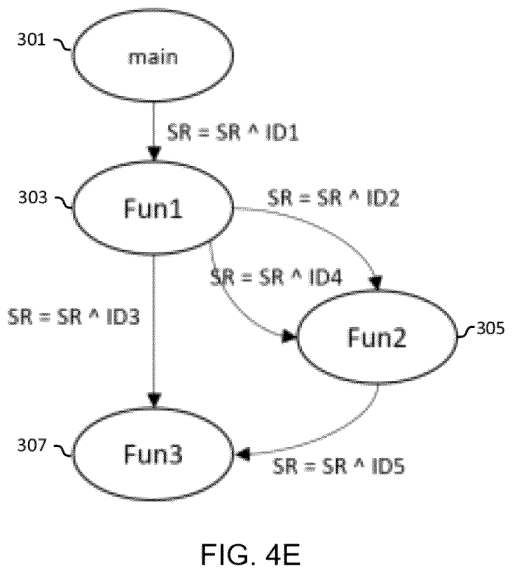

The plugin 131b may further replace return (RET) instructions with hard-coded jump tables depending on the generated control flow graph, and the expected SR value given a specific path. The jump table may have “lm j” instructions embedded as visualized in the FIGS. 4a-e. Furthermore, FIG. 4A represents the main function 301 of FIG. 4E, FIG. 4B represents a further first function 303 of FIG. 4E, FIG. 4C represents a further second function 305 of FIG. 4E, FIG. 4D represents a further third function 307 of FIG. 4E. In FIG. 4A to FIG. 4C, the unique key Kx is an identifier indicated as “ID1” to “ID5”.

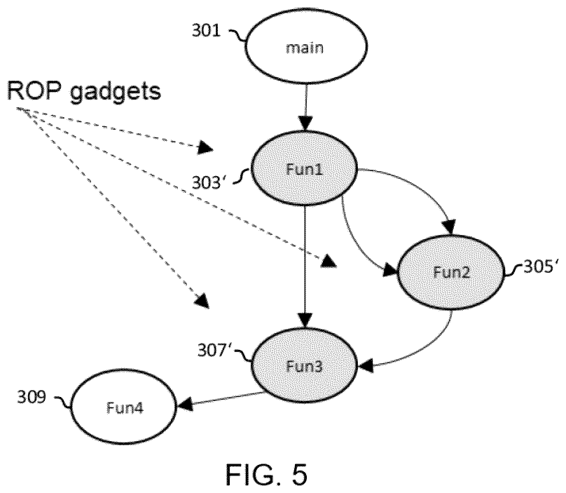

Considering the control flow graph as illustrated in FIG. 3, FIGS. 4a-e show the instrumentation effects on the several functions 301-307 indicating call instructions. As will be appreciated, RET instructions may only be replaced with hard-coded jump tables for functions that comprises ROP gadgets. This means that all root and leaf functions are excluded from this RET instrumentation. Functions 303′-307′ with ROP gadgets are illustrated in FIG. 5.

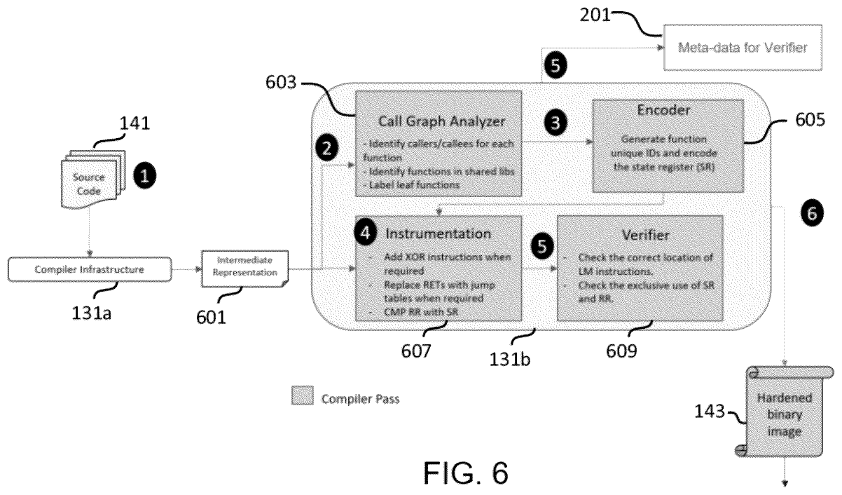

FIG. 6 shows the compiling process performed by the second data processing 130 according to an embodiment in more detail.

As illustrated, in FIG. 6, after the source code 141 is provided to the compiler infrastructure 131a, the plugin 131b and/or the compiler infrastructure 131a may output an intermediate representation of the code that is close to assembly language but is still human readable.

Based on the intermediate representation 601 a graph analyser module 603 implemented by the plugin 131b may identify callers/callees for each function 301-309, identify functions 301-309 in shared libs and label leaf functions 301-309.

Based on the processing of the graph analyser module 603, an encoder 605 implemented by the plugin 131b may generate the function unique identifiers (IDs), i.e. unique keys Kx, and encode the state register SR.

Based on the encoding performed by the encoder 605 and the intermediate representation 601 an instrumentation module 607 may add XOR instructions when required, as described above, replace RETs with jump tables when required, as described above, and compare RR with SR, as described above.

Based on the processing of the instrumentation module 607 a verifier module 609 may check the correct location of the LM instructions and check the exclusive use of SR and RR. The verifier module 609 may be connectable with the verifier server 120 and may exchange data with the verifier server 120, in particular for transmitting the meta-data 201 to the verifier server 120.

Once verified by the verifier module 609, the second data processing apparatus 130 may provide the such hardened version 143 of the application machine code 141 to the first data processing apparatus 110.

Any application can be compiled by a compiler that supports the associated custom compiler plugin 131b. Any violation detected due to either (i) a mismatch between register values or (ii) indirectly targeting a non-landmark instruction may trigger the custom LM exception handler 207 of the first data processing apparatus 110. The main task of the custom LM exception handler 207 may be logging violations in a trustworthy way and stopping the compromised process. The remote attestation agent 203 of the first data processing apparatus 110 may retrieve these logs based on request and send them to the verifier server 120 for validation.

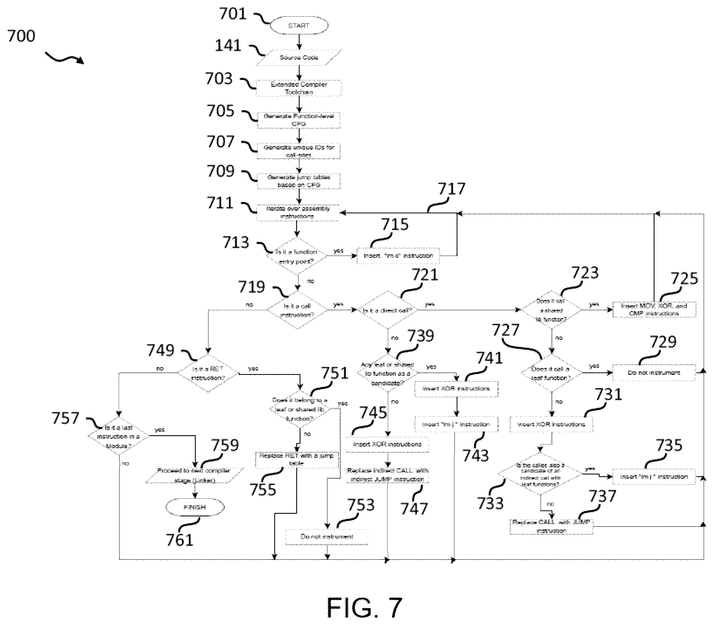

FIG. 7 is a flow diagram illustrating an instrumentation sequence 700 implemented by the second data processing apparatus 130 according to an embodiment during compilation.

Following a start 701 of the instrumentation sequence 700, the source code 141 may be provided to the extended compiler toolchain 703, i.e. the compiler infrastructure 131a and the plugin 131b.

In step 705 of FIG. 7, the function-level control flow graph (CFG) may be generated.

In step 707 of FIG. 7, the unique IDs, i.e. the unique keys Kx, may be generated for call-sites.

In step 709 of FIG. 7, the jump tables may be generated based on the CFG.

In step 711 of FIG. 7, the second data processing apparatus 130 may iterate over the assembly instructions.

In step 713 of FIG. 7, the second data processing apparatus 130 may check if the current assembly instruction is a function entry point. If true, the instrumentation sequence 700 may proceed with step 715 of FIG. 7. If false, the instrumentation sequence 700 may proceed with step 719 of FIG. 7.

In step 715 of FIG. 7, the second data processing apparatus 130 may insert the “lm c” instruction. Following step 715, for finishing the current iteration loop 717, the instrumentation sequence 700 may proceed with step 711.

In step 719 of FIG. 7, the second data processing apparatus 130 may check if the current assembly instruction is a call instruction. If true, the instrumentation sequence 700 may proceed with step 721 of FIG. 7. If false, the instrumentation sequence 700 may proceed with step 749 of FIG. 7.

In step 721 of FIG. 7, the second data processing apparatus 130 may check if the current assembly instruction is a direct call. If true, the instrumentation sequence 700 may proceed with step 723 of FIG. 7. If false, the instrumentation sequence 700 may proceed with step 739 of FIG. 7.

In step 723 of FIG. 7, the second data processing apparatus 130 may check if the current assembly instruction is a shared lib function. If true, the instrumentation sequence 700 may proceed with step 725 of FIG. 7. If false, the instrumentation sequence 700 may proceed with step 727 of FIG. 7.

In step 725 of FIG. 7, the second data processing apparatus 130 may insert the MOV, XOR and CMP instructions. Following step 725, for finishing the current iteration loop 717, the instrumentation sequence 700 may proceed with step 711.

In step 727 of FIG. 7, the second data processing apparatus 130 may check if the current assembly instruction calls a leaf function. If true, the instrumentation sequence 700 may proceed with step 729 of FIG. 7. If false, the instrumentation sequence 700 may proceed with step 731 of FIG. 7.

In step 729 of FIG. 7, the second data processing apparatus 130 may choose to not perform instrumentation in the current iteration loop 717. Following step 729, for finishing the current iteration loop 717, the instrumentation sequence 700 may proceed with step 711.

In step 731 of FIG. 7, the second data processing apparatus 130 may insert the XOR instructions. Following step 731 the instrumentation sequence 700 may proceed with step 733.

In step 733 of FIG. 7, the second data processing apparatus 130 may check if the callee is also a candidate of an indirect call with leaf functions. If true, the instrumentation sequence 700 may proceed with step 735 of FIG. 7. If false, the instrumentation sequence 700 may proceed with step 737 of FIG. 7.

In step 735 of FIG. 7, the second data processing apparatus 130 may insert the “lm j” instruction. Following step 735, for finishing the current iteration loop 717, the instrumentation sequence 700 may proceed with step 711.

In step 737 of FIG. 7, the second data processing apparatus 130 may replace the call instruction with the jump instruction. Following step 737, for finishing the current iteration loop 717, the instrumentation sequence 700 may proceed with step 711.

In step 739 of FIG. 7, the second data processing apparatus 130 may check if there are any leaf or shared lib functions as a candidate. If true, the instrumentation sequence 700 may proceed with step 741 of FIG. 7. If false, the instrumentation sequence 700 may proceed with step 745 of FIG. 7.

In step 741 of FIG. 7, the second data processing apparatus 130 may insert the XOR instructions. Following step 741 the instrumentation sequence 700 may proceed with step 743.

In step 743 of FIG. 7, the second data processing apparatus 130 may insert the “lm j” instruction. Following step 743, for finishing the current iteration loop 717, the instrumentation sequence 700 may proceed with step 711.

In step 745 of FIG. 7, the second data processing apparatus 130 may insert the XOR instructions. Following step 745 the instrumentation sequence 700 may proceed with step 747.

In step 747 of FIG. 7, the second data processing apparatus 130 may replace the indirect call instruction with the indirect jump instruction. Following step 747, for finishing the current iteration loop 717, the instrumentation sequence 700 may proceed with step 711.

In step 749 of FIG. 7, the second data processing apparatus 130 may check if the current assembly instruction is a RET instruction. If true, the instrumentation sequence 700 may proceed with step 751 of FIG. 7. If false, the instrumentation sequence 700 may proceed with step 757 of FIG. 7.

In step 751 of FIG. 7, the second data processing apparatus 130 may check if the current assembly instruction belongs to a leaf or shared lib function. If true, the instrumentation sequence 700 may proceed with step 753 of FIG. 7. If false, the instrumentation sequence 700 may proceed with step 755 of FIG. 7.

In step 753 of FIG. 7, the second data processing apparatus 130 may choose to not perform instrumentation in the current iteration loop 717. Following step 753, for finishing the current iteration loop 717, the instrumentation sequence 700 may proceed with step 711.

In step 755 of FIG. 7, the second data processing apparatus 130 may replace RET with a jump table. Following step 755, for finishing the current iteration loop 717, the instrumentation sequence 700 may proceed with step 711.

In step 757 of FIG. 7, the second data processing apparatus 130 may check if the current assembly instruction is a last instruction in a module. If true, the instrumentation sequence 700 may proceed with step 759 of FIG. 7. If false, for finishing the current iteration loop 717, the instrumentation sequence 700 may proceed with step 711.

In step 759 of FIG. 7, the second data processing apparatus 130 may proceed to the next compiler stage, i.e. the linker, in order to finish 761 the instrumentation sequence 700.

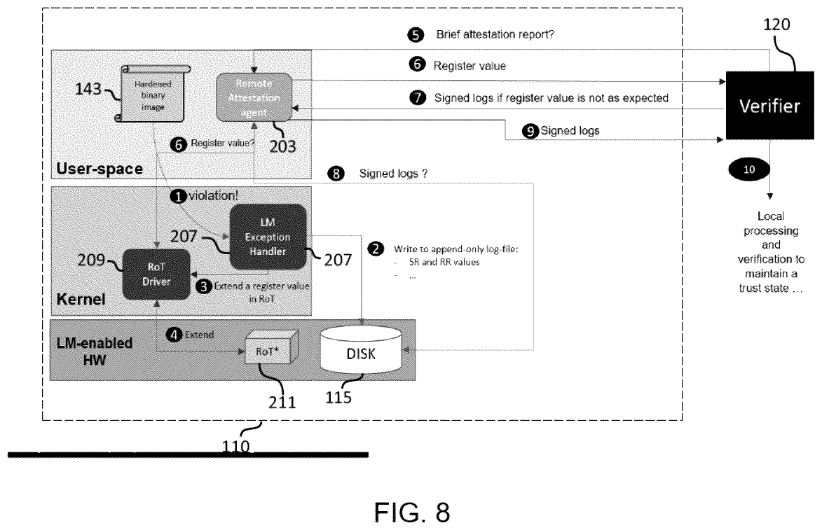

FIG. 8 is a schematic diagram illustrating the architecture of the runtime attestation system 100 according to an embodiment at runtime. When the target application, i.e. the hardened version 143 of the application machine code 141 is deployed, it may keep running normally without disclosing or logging any information. The inline instrumentation may calculate excepted reference values during execution. If something wrong happens, i.e. a violation occurs as illustrated by the circle 1 in FIG. 8, the LM exception handler 207 is triggered. The LM exception handler 207 may also be triggered if an indirect branch instruction targets a non-LM instruction. In any case, when the LM exception handler 207 is triggered, as illustrated by the circle 2 in FIG. 8, it will log only the value of SR and RR registers in an append-only log file that is saved in the non-volatile memory 115 and its integrity may be verified using a static remote attestation scheme. As illustrated by the circles 3 and 4 in FIG. 8, the LM exception handler 207 may also anchor the hash value of the added record in the ROT hardware component 211 through the ROT driver 209 to detect any tampering that might happen in the future. Finally, the LM exception handler 207 may stop the corresponding user-space process because it is most likely compromised.

As illustrated by the circle 5 in FIG. 8, at any point in time, if the verifier server 120 is interested to attest the runtime integrity status of the first data processing device 110, it may send an attestation request to the remote attestation agent 203 questioning about the value of the dedicated register in the ROT hardware module 211.

As illustrated by the circle 6 in FIG. 8, the remote attestation agent 203 may query this value from the RoT hardware module 211 through the ROT driver 209 and send it back to the verifier server 120. If the value is as expected (for example zero), then the attestation process is terminated at this stage and a conclusion is made that the first data processing device 110 is in the benign state. Otherwise, as illustrated by the circle 7 in FIG. 8, the verifier server 120 may proceed with the attestation process asking for the entire signed log file.

As illustrated by the circles 8 and 9 in FIG. 8, the remote attestation agent 203 may retrieve this log file from the non-volatile memory 115 and send it back along with all meta-data needed from the ROT hardware module 211 to verify its integrity and authenticity.

As illustrated by the circle 10 in FIG. 8, the verifier server 120 may then perform further investigation on the execution state of the first data processing device 110 depending on the received SR and RR register values. The verifier server 120 may output the function names along with followed paths that have been executed (possibly by the attacker) to trigger the LM exception handler 207.

Advantageously, embodiments described herein can provide both prevention and detection capabilities, i.e. enables both control-flow integrity (CFI) and control-flow attestation (CFA). This can cover all control-flow hijacking attacks. Also by providing both prevention and detection capabilities along with trustworthy evidence about the runtime integrity status of a device such as the at least one first data processing apparatus 110 to a trusted party such as the verifier server 120, embodiments described herein can be very beneficial in many scenarios such as cloud services.

Embodiments described herein are also completely transparent in the sense that they do not depend on secrets, and thus are very robust against many attacks. Embodiments described herein can also be scalable to complex software stacks and can be very efficient in terms of performance overhead. By providing CFI capabilities along with context awareness due to the use of XOR chains with unique IDs the verifier server 120 can reconstruct the latest execution paths when needed. Unlike some CFA mechanisms, embodiments herein can report two register values (SR and RR) as a report when needed which can be enough to reconstruct the latest execution trace when needed. Given the small size of the attestation data 145, i.e. reports, and the deterministic way of verifying them, the verifier functionality can be scaled to handle a large number of first data processing apparatus 110. When the target application, i.e. the hardened version 143 of the application machine code 141 is deployed, it can keep running normally without disclosing or logging any information.

Embodiments described herein can make launching control-flow hijacking attacks (i) very difficult, (ii) detectable, and (iii) verifiable. Embodiments described herein may be based on a hardware-software co-design of a fine-grained control flow integrity and attestation scheme that comprises one or more of the following features:

Hardware-assisted landmark instructions may be inserted to limit valid targets for indirect branches (call and jump instructions). Accordingly, if such instructions exist, indirect branches can only target them. Otherwise, an exception may be fired.

Return (RET) instructions may be replaced with hard-coded jump tables to eliminate ROP gadgets.

Two registers may be dedicated that may be updated via XOR operations when executing any control-transfer instruction to stay aware of the execution context.

The value of the registers may be linked with the memory address of the correct jump destinations to minimize the look-up time in the hard-coded jump tables.

Unique IDs may be assigned to each branch instruction, and thus can be fine-grained at the branch-site level.

Violations may be detected and reported with the custom LM exception handler 207.

Verifying results may be allowed to be easily and quickly, thus scalable.

Embodiments described herein can be applied to any product in any scenario if there is any interest to attest the runtime integrity status of the target device such as the at least one first data processing apparatus 110. For instance, it can be applied to implantable medical devices if the required hardware support is found, which hold a safety-critical software that can be attested by doctors or by the patients themselves if needed. This disclosure can also be applied to the various electronic control units (ECUs) in cars to enable this sort of implicit runtime attestation, and thus not hindering the safety of many critical components. In short, this disclosure can be applied in many technical fields.

The hardware part of embodiments described herein can be realized in the new generation of ARM and Intel architectures. Thus, embodiments described herein can be effectively applied to many products in the ICT domain. Unlike some approaches, the instrumentation part in embodiments described herein is not static, but dynamic, in particular computations (via XOR operations) to preserve context awareness.

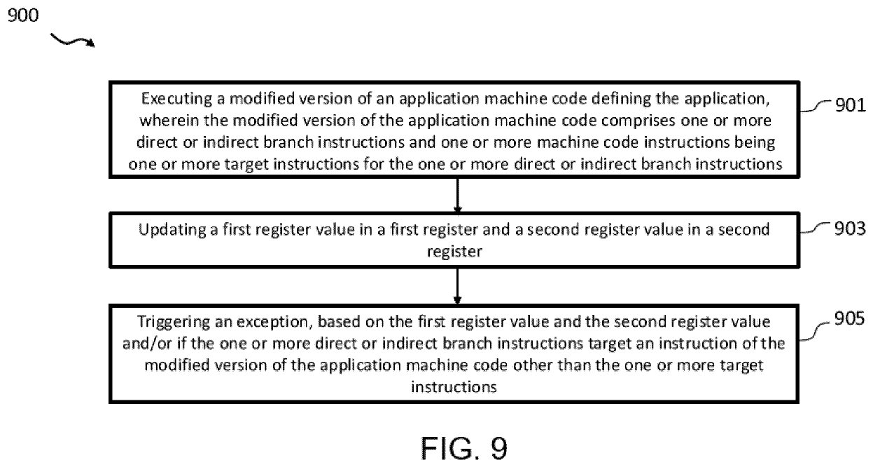

FIG. 9 shows a flow diagram illustrating a method 900 for executing the software application defined by the application machine code 141, e.g. a target binary image.

The method 900 comprises a step of executing 901 the modified version 143 of the application machine code 141 defining the application, wherein the modified version 143 of the application machine code 141 comprises one or more direct or indirect branch instructions and one or more machine code instructions being one or more target instructions for the one or more direct or indirect branch instructions.

The method 900 further comprises a step of updating 903 a first register value in a first register and a second register value in a second register.

The method 900 further comprises a step of triggering 905 an exception, based on the first register value and the second register value and/or if the one or more direct or indirect branch instructions target an instruction of the modified version 143 of the application machine code 141 other than the one or more target instructions.

As the method 900 can be implemented by the first data processing apparatus 110, further features of the method 900 result directly from the functionality of the first data processing apparatus 110 and its different embodiments described above and below.

The person skilled in the art will understand that the “blocks” (“units”) of the various figures (method and apparatus) represent or describe functionalities of embodiments of the present disclosure (rather than necessarily individual “units” in hardware or software) and thus describe equally functions or features of apparatus embodiments as well as method embodiments (unit=step).

In the several embodiments provided in the present application, it should be understood that the disclosed system, apparatus, and method may be implemented in other manners. The described embodiment of an apparatus is merely exemplary. For example, the unit division is merely logical function division and may be another division in an actual implementation. For example, a plurality of units or components may be combined or integrated into another system, or some features may be ignored or not performed. In addition, the displayed or discussed mutual couplings or direct couplings or communication connections may be implemented by using some interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on a plurality of network units. Some or all of the units may be selected according to actual needs to achieve the objectives of the solutions of the embodiments.

In addition, functional units in the embodiments described herein may be integrated into one processing circuitry, or each of the units may exist alone physically, or two or more units are integrated into one unit.

1. A data processing apparatus comprising:
a memory comprising:
application machine code defining an application;
a first register having a first register value; and
a second register having a second register value; and
a processing circuitry coupled to the memory and configured to:
execute a modified version of the application machine code, wherein the modified version comprises direct branch instructions and machine code instructions wherein the machine code instructions are target instructions for the direct branch instructions;
update, during execution of the modified version, the first register value and the second register value; and
trigger a first exception based on the first register value and the second register value and/or when the direct branch instructions target an instruction of the modified version other than the target instructions.

2. The data processing apparatus of claim 1, further comprising a communication interface configured to report attestation data to a verifier server when the processing circuitry triggers the first exception, wherein the attestation data comprises information about the first register value and/or the second register value.

3. The data processing apparatus of claim 2, wherein the information comprises the first register value, the second register value, and/or a digest value that is based on the first register value and/or the second register value.

4. The data processing apparatus of claim 1, wherein the direct branch instructions comprise direct call instructions, direct jump instructions, and/or direct return instructions.

5. The data processing apparatus of claim 1, wherein, for each of the direct branch instructions, the processing circuitry is further configured to:
move a current first register value of the first register to the second register;
update the current first register value by a first exclusive OR (XOR) operation with a unique identifier;
perform the direct branch instructions;
update the current first register value by a second XOR operation with the unique identifier to obtain an updated current first register value; and
compare the updated current first register value with the second register value.

6. The data processing apparatus of claim 5, wherein the processing circuitry is further configured to trigger if a second exception when the updated current first register value is different from the second register value.

7. The data processing apparatus of claim 5, wherein the processing circuitry is further configured to generate or obtain the unique identifier for each of the direct branch instructions.

8. The data processing apparatus of claim 1, wherein the processing circuitry is further configured to modify the first register and the second register using an assignment instruction, an exclusive OR (XOR) instruction, and a compare instruction.

9. The data processing apparatus of claim 1, wherein the modified version comprises a jump table defining jump destinations for return instructions of an original version of the application machine code.

10. The data processing apparatus of claim 9, wherein the processing circuitry is further configured to link the first register value with a memory address of the jump destinations.

11. A runtime attestation system, comprising:
data processing apparatus configured to:
generate attestation data;
execute a modified version of an application machine code defining an application, wherein the modified version comprises direct branch instructions and machine code instructions, wherein the machine code instructions are target instructions for the direct branch instructions;
update, during execution of the modified version, a first register value in a first register and a second register value in a second register; and
trigger a first exception based on the first register value and the second register value and/or when the direct branch instructions target an instruction of the modified version other than the target instructions; and
a verifier server coupled to the data processing apparatus and configured to:
receive, from the data processing apparatus, the attestation data, and
attest, based on the attestation data, an integrity of the data processing apparatus.

12. A method comprising:
executing a modified version of an application machine code defining an application, wherein the modified version comprises direct branch instructions and machine code instructions, wherein the machine code instruction are target instructions for the direct branch instructions;
updating a first register value in a first register and a second register value in a second register; and
triggering an exception based on the first register value and the second register value and/or when the direct branch instructions target an instruction of the modified version other than the target instructions.

13. A data processing apparatus comprising:
a memory configured to store instructions; and
one or more processors coupled to the memory, wherein when executed by the processor, the instructions cause the data processing apparatus to:
modify an original version of an application machine code defining an application into a modified version of the application machine code, wherein the original version of by including, for each of direct branch instructions of the original version, machine code instructions indicating target instructions for the direct branch instructions; and
compile the modified version into an executable binary image.

14. The data processing apparatus of claim 13, wherein the direct or branch instructions comprise direct call instructions, direct jump instructions, and/or direct return instructions.

15. The data processing apparatus of claim 13, wherein the original version comprises return instructions, and wherein when executed by the one or more processors, the instructions further cause the data processing apparatus to include, for each of the return instructions, a jump table defining jump destinations.

16. The runtime attestation system of claim 11, wherein the data processing apparatus is further configured to report the attestation data to the verifier server when triggering the first exception, and wherein the attestation data comprises information about the first register value and/or the second register value.

17. The runtime attestation system of claim 16, wherein the information comprises the first register value, the second register value, and/or a digest value that is based on the first register value and/or the second register value.

18. The runtime attestation system of claim 11, wherein the direct branch instructions comprise direct call instructions, direct jump instructions, and/or direct return instructions.

19. The runtime attestation system of claim 11, wherein, for each of the direct branch instructions, the data processing apparatus is further configured to:
move a current first register value of the first register to the second register;
update the current first register value by a first exclusive OR (XOR) operation with a unique identifier;
perform the direct branch instructions;
update the current first register value by a second XOR operation with the unique identifier to obtain an updated current first register value; and
compare the updated current first register value with the second register value.

20. The runtime attestation system of claim 19, wherein the data processing apparatus is further configured to trigger a second exception when the updated current first register value is different from the second register value.
